(19) United States
(12) Patent Application Publication
(10) Pub. No.: US 2025/0095288 A1
(43) Pub. Date: Mar. 20, 2025

(54) DEVICE, METHOD AND PROGRAM THAT CREATE 3D MODELS

(71) Applicant: NIPPON TELEGRAPH AND TELEPHONE CORPORATION, Tokyo (JP)

(72) Inventors: Yusuke SAKURAHARA, Musashino-shi, Tokyo (JP); Yukihiro GOTO, Musashino-shi, Tokyo (JP); Masaki WAKI, Musashino-shi, Tokyo (JP); Takashi EBINE, Musashino-shi, Tokyo (JP)

(73) Assignee: NIPPON TELEGRAPH AND TELEPHONE CORPORATION, Tokyo (JP)

(21) Appl. No.: 18/727,330

(22) PCT Filed: Jan. 14, 2022
(86) PCT No.: PCT/JP2022/001023

§ 371 Date: Jul. 8, 2024

(51) Int. Cl. G06T 17/00; G06T 19/20

(52) U.S. Cl. CPC G06T 17/00; G06T 19/20; G06T 2219/2012

(57) ABSTRACT

An object of the present disclosure is to enable a three-dimensional model to be created even for a target object which has unevenly spaced inter-point distances and only a part of a point cloud. According to the present disclosure, there are provided an apparatus and a method in which a three-dimensional model of a target object is created from point cloud data in which each point represents three-dimensional coordinates, the three-dimensional model is superimposed on an image in which a target object of the three-dimensional model is photographed, a point cloud data to be added to a point cloud data that constitutes the three-dimensional model is selected by comparing the three-dimensional model with the target object in the image, and the three-dimensional model of the target object is created again using the point cloud data including the point cloud to be added.

### TECHNICAL FIELD

The present disclosure relates to a technology for creating a three-dimensional model from point cloud data representing three-dimensional coordinates.

### BACKGROUND ART

A technology for three-dimensionally modeling an outdoor structure by an in-vehicle three-dimensional laser scanner (mobile mapping system: MMS) has been developed (for example, refer to Patent Literature 1). In the technology of Patent Literature 1, a point cloud and a scan line are created in a space where no point cloud exists, and then a three-dimensional model is created.

There is a need to realize three-dimensional modeling of cylindrical objects using point cloud data acquired by a fixed three-dimensional laser scanner. However, since the MMS can acquire the point cloud while moving along the target object, the point cloud of the measurement range can be acquired evenly and at equal intervals to some extent. However, the fixed three-dimensional laser scanner produces a dense point cloud at a short distance from the measurement point, and a sparse point cloud at a long distance. Therefore, in the creation of the three-dimensional model using the point cloud data acquired by the fixed three-dimensional laser scanner, this characteristic significantly appears depending on the size and shape of the target object,

In the related art, points are interpolated until the distance between point clouds reach a certain threshold to form a scan line. However, in a case where the distance between point clouds is large and the point clouds are not regarded as point clouds on the same target object, no point can be interpolated between points. Therefore, in the three-dimensional modeling by the fixed three-dimensional laser scanner, a problem arises in that it is difficult to create a three-dimensional model of a target object having a small diameter, such as a cable on a utility pole.

### CITATION LIST

### Patent Literature

Patent Literature 1: JP 2017-156179 A

### SUMMARY OF INVENTION

### Technical Problem

An object of the present disclosure is to enable a three-dimensional model to be created even for a target object which has unevenly spaced inter-point distances and only a part of a point cloud.

### Solution to Problem

According to the present disclosure, there are provided an apparatus and a method in which
a three-dimensional model of a target object is created from point cloud data in which each point represents three-dimensional coordinates,
the three-dimensional model is superimposed on an image in which a target object of the three-dimensional model is photographed
a point cloud data to be added to a point cloud data that constitutes the three-dimensional model is selected by comparing the three-dimensional model with the target object in the image, and
the three-dimensional model of the target object is created again using the point cloud data including the point cloud to be added.

### Advantageous Effects of Invention

According to the present disclosure, it is possible to create a three-dimensional model of a target object not depending on the distance between three-dimensional points. Therefore, the present disclosure enables a three-dimensional model to be created even for a target object which has unevenly spaced inter-point distances and only a part of a point cloud.

### BRIEF DESCRIPTION OF DRAWINGS

FIG. 1 illustrates an example of point cloud data.

FIG. 2 illustrates an example of a three-dimensional model in which a structure is objectified.

FIG. 3 illustrates a system configuration example according to the present disclosure.

FIG. 4 illustrates an example of a point cloud stored in a storage medium.

FIG. 5 illustrates an example of an image stored in the storage medium.

FIG. 6 illustrates an example of a method of the present embodiment.

FIG. 7 illustrates an example of a three-dimensional model created in step S1.

FIG. 8 illustrates an example of superimposition of a three-dimensional model image in step S2.

FIG. 9 illustrates an example of a corrected three-dimensional model.

FIG. 10 illustrates a specific example of step S3.

FIG. 11 illustrates an example of a first method of comparing sizes of target objects.

FIG. 12 illustrates an example of adding a point cloud constituting the three-dimensional model.

FIG. 13 illustrates an example of a corrected three-dimensional model.

FIG. 14 illustrates an example of a second method of comparing sizes of target objects.

FIG. 15 illustrates a specific example of step S3.

FIG. 16 illustrates an example of processing in which point clouds of different colors are set as endpoints,

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be carried out in forms of various modifications and improvements based on knowledge of those skilled in the art. Components assigned the same reference numerals in the present specification and the drawings are the same components,

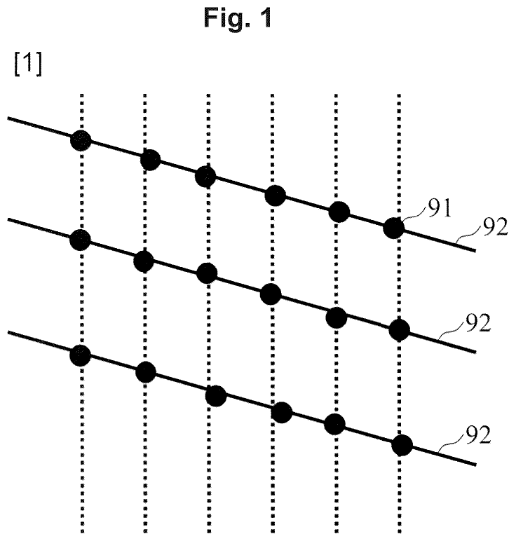

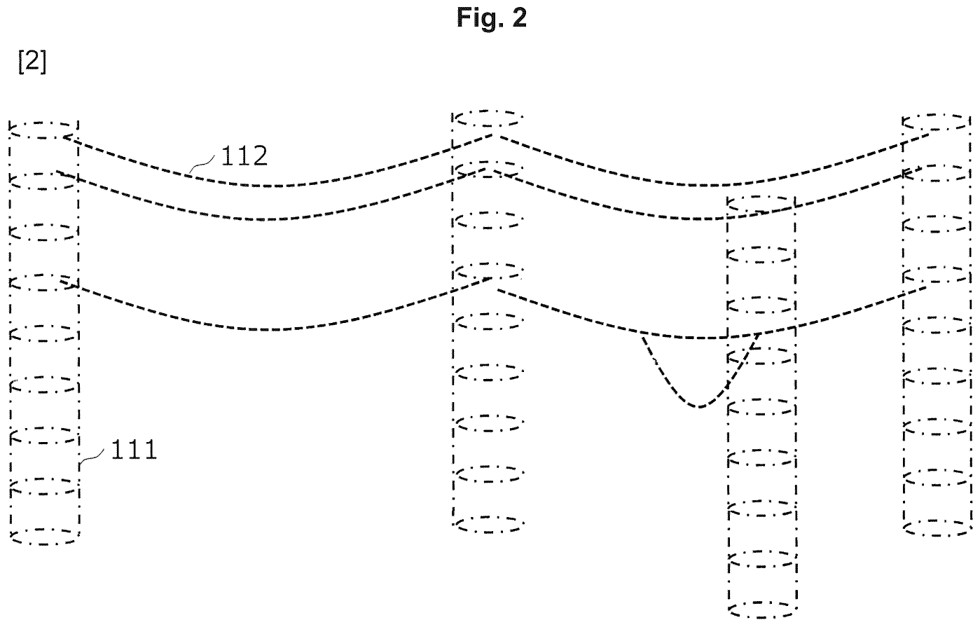

The present disclosure provides an apparatus and a method for creating a three-dimensional model of a target object from point cloud data representing three-dimensional coordinates acquired by a three-dimensional laser scanner. FIG. 1 illustrates an example of point cloud data. The point cloud data is data representing a surface shape of a target object such as a structure as a set of points 91, and individual points 91 represent three-dimensional coordinates on a surface of the structure. By forming a line 92 connecting the points 91 of the three-dimensional point cloud data, it is possible to create a three-dimensional model in which a structure is objectified. For example, as illustrated in FIG. 2, a three-dimensional utility pole model 111 and a cable model 112 can be created.

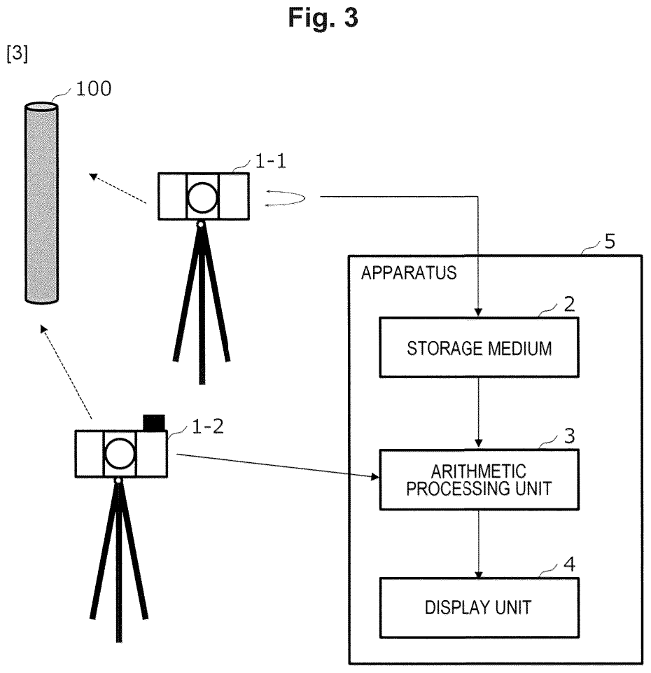

FIG. 3 illustrates a system configuration example of the present disclosure. The system of the present disclosure includes a fixed three-dimensional laser scanner 1-1 for measuring a target object 100, a camera 1-2 for imaging the target object 100, and an apparatus 5 of the present disclosure. The apparatus 5 of the present disclosure includes an arithmetic processing unit 3 and a display unit 4, and may further include a storage medium 2. Further, the apparatus 5 of the present disclosure can also be implemented by a computer and a program, and the program can be recorded in a recording medium or provided through a network.

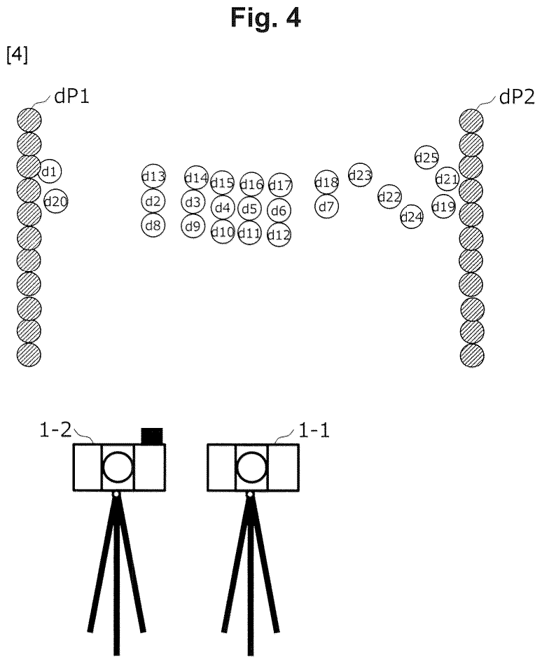

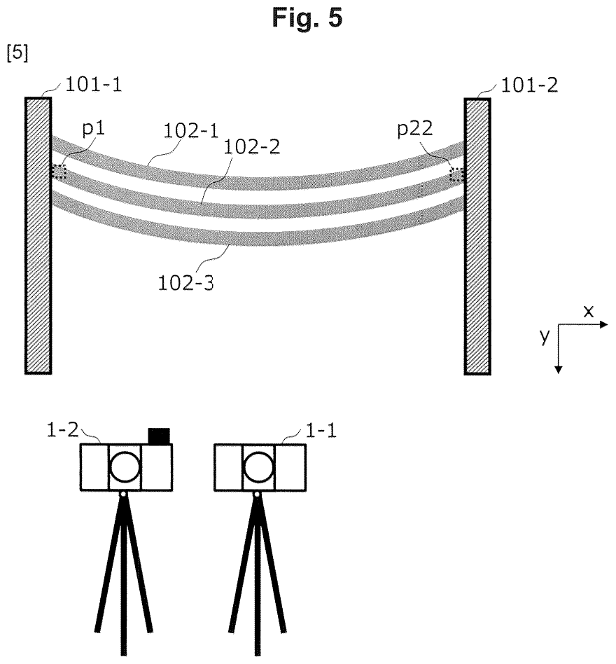

The system of the present disclosure stores the point cloud data acquired by the fixed three-dimensional laser scanner 1-1 and the image captured by the camera 1-2 in the storage medium 2. FIG. 4 illustrates an example of a point cloud stored in the storage medium 2. In the present embodiment, the points d1 to d25 are stored between the measured point clouds dp1 and dp2 of the utility pole. FIG. 5 illustrates an example of an image stored in the storage medium 2. In the present embodiment, an image in which the cables 102-1, 102-2, and 102-3 are stretched between the utility poles 101-1 and 101-2 is stored.

The camera 1-2 may be a camera mounted on the fixed three-dimensional laser scanner 1-1 or may be prepared separately. In addition, the camera 1-2 desirably captures an image at a position, a direction, and an angle of view similar to the position, the direction, and the angle of view at which the fixed three-dimensional laser scanner 1-1 acquires the point cloud. Accordingly, superimposition of the point cloud acquired by the fixed three-dimensional laser scanner 1-1 and the image captured by the camera 1-2 is facilitated. However, since the point cloud of the present disclosure has three-dimensional coordinates, it is possible to superimpose the point cloud on the image based on the relative position as long as there is the three-dimensional position information of the fixed three-dimensional laser scanner 1-1 and the camera 1-2.

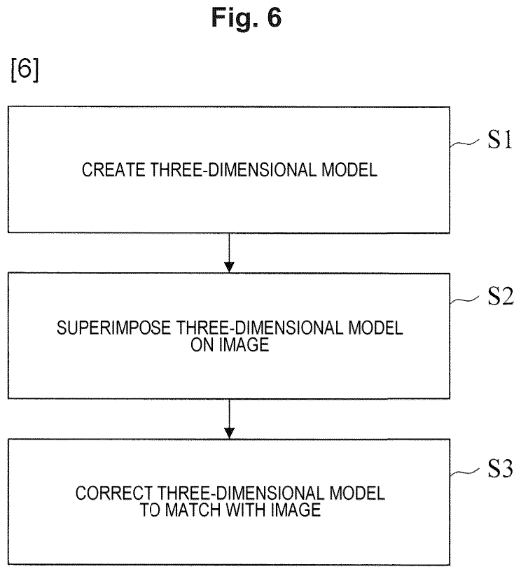

FIG. 6 illustrates an example of a method of the present embodiment. The method according to the present embodiment, which is a method of generating a three-dimensional model of a target object from point cloud data acquired by the three-dimensional laser scanner 1-1, the method including: a step S1 of creating, by the arithmetic processing unit 3, a three-dimensional model of the target object from the three-dimensional point cloud data;

a step S2 of superimposing, by the arithmetic processing unit 3, the created three-dimensional model of the target object on the image of the target object; and a step S3 of correcting, by the arithmetic processing unit 3, the three-dimensional model based on the comparison between the three-dimensional model and the superimposed image.

In step S1, a target object is extracted from the point cloud and a three-dimensional model is created (DBSCAN). Here, DBSCAN is one clustering technique and is a technique in which a point cloud included in the condition that there are more than a certain number of points within the threshold of a certain point is considered as a mass and is treated as a cluster. The target object is, for example, the utility poles 101-1 and 101-2 or cables 102-1, 102-2, and 102-3. Hereinafter, an example in which the target objects are the cables 102-1, 102-2, and 102-3 will be described.

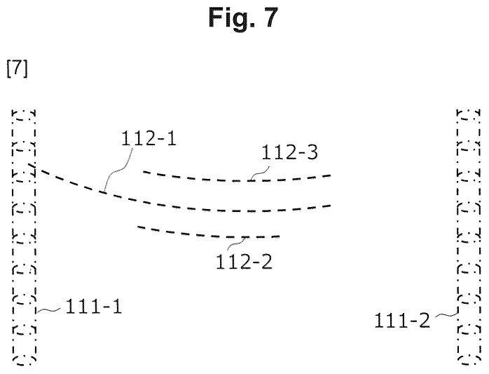

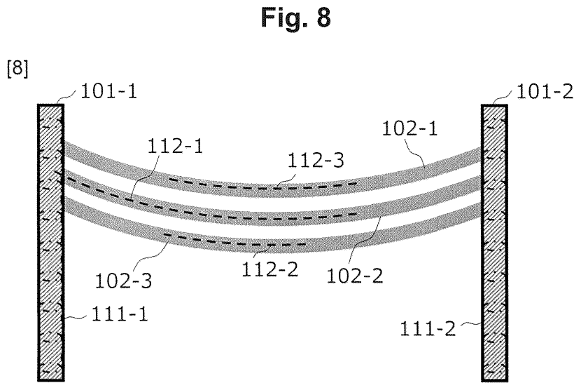

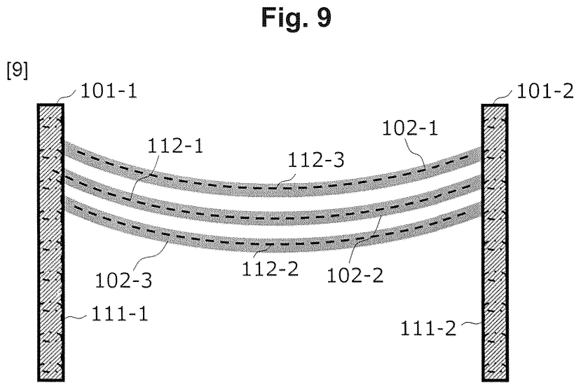

FIG. 7 illustrates an example of three-dimensional models 112-1, 112-2, and 112-3 created in step S1. In step S2, the three-dimensional models 112-1, 112-2, and 112-3 are superimposed on an image as illustrated in FIG. 8. Then, by comparing the three-dimensional models 112-1, 112-2, and 112-3 with the cables 102-1, 102-2, and 102-3 in the image in step S3, the three-dimensional models 112-1, 112-2, and 112-3 are corrected as illustrated in FIG. 9. As a result, the present disclosure can calculate facility information (looseness, span length, and the like) from the corrected three-dimensional model. The display unit 4 may display the images illustrated in FIGS. 7 to 9.

In the present disclosure, it is possible to determine whether the three-dimensional model has been completely created by superimposing the image in step S2, and in step S3, the existing three-dimensional model can be left as it is, and when the three-dimensional model is insufficient, the three-dimensional model can be added. As a result, the present disclosure can determine the presence or absence of a target object even when the target object has only a part of the point cloud. Therefore, the present disclosure can construct a three-dimensional model of a thin line-shaped target object such as a suspension line, an optical cable, an electric wire, or a horizontal support line. Furthermore, the present disclosure can construct a three-dimensional model of a target object in a thin line shape, and thus it is possible to detect a state of target facility in a thin line shape.

In step S3, the arithmetic processing unit 3 can automatically correct the three-dimensional model, and the method is random. In the present embodiment, a mode of interpolating a point to be matched with an image and a mode of interpolating a model to be matched with an image will be exemplified.

### First Embodiment

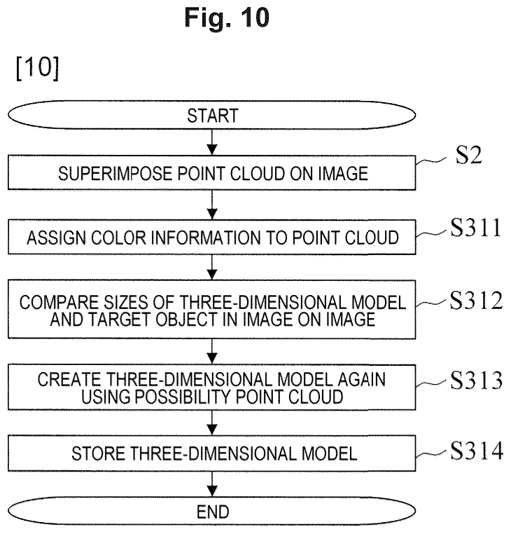

FIG. 10 illustrates a specific example of step S3. In the present embodiment, the arithmetic processing unit 3 superimposes the created three-dimensional model on the photographed image (S2), assigns color information to the point cloud (S311), and compares the sizes of the three-dimensional model and the target object in the image on the image (S312). When the target object in the image is larger, the point is interpolated to create a three-dimensional model (S313), and the three-dimensional model is stored in the storage medium 2 (S314).

Here, the present embodiment is performed on the premise that the target object is horizontally oriented with respect to the acquisition range of the three-dimensional laser scanner. In step S312, a method of superimposing the image and the point cloud and comparing the size of the target object is random, but for example, the following method can be exemplified.

First method: A method of superimposing a point cloud and an image, and comparing the size determined by color pixels of a target object in the image with the size of a three-dimensional model.

Second method: A method of comparing the shape and size of a target object extracted from an image by image analysis with the size and shape of a three-dimensional model created from a point cloud.

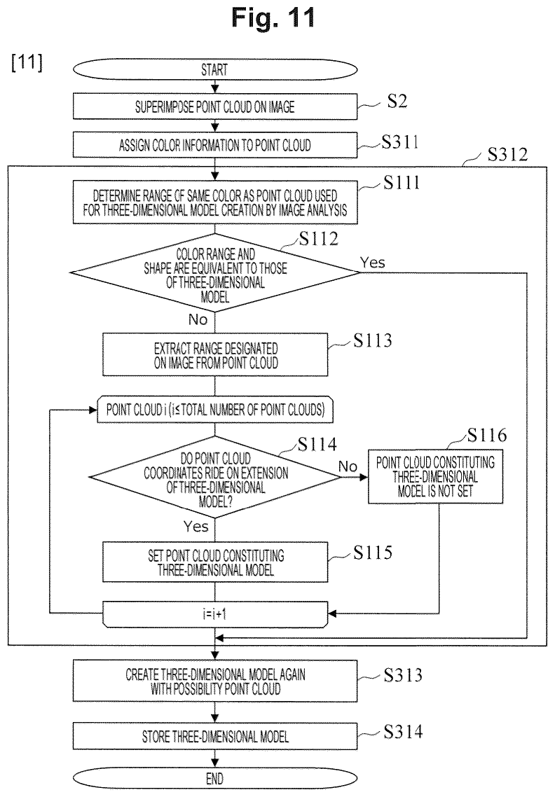

FIG. 11 illustrates an example of the first method.

The arithmetic processing unit 3 executes the following processing.
S2: Superimpose the point cloud and the image.
S311: Assign color information to the point cloud.
S111: Determine how far the point cloud used for three-dimensional model creation extends in the image.
S112: Compare the determined color range with the extracted three-dimensional model to check whether they are the same.
S113; Extract a range (pixels of the same color) determined in the image from the point cloud.
S114 to S116: Determine whether the extracted point cloud is a possibility for the three-dimensional model.
S313: Create the three-dimensional model again using the possibility point cloud, and correct the shape of the three-dimensional model. Specifically, create the model again using the feature point cloud,
S314: Store the final three-dimensional model and end the process.

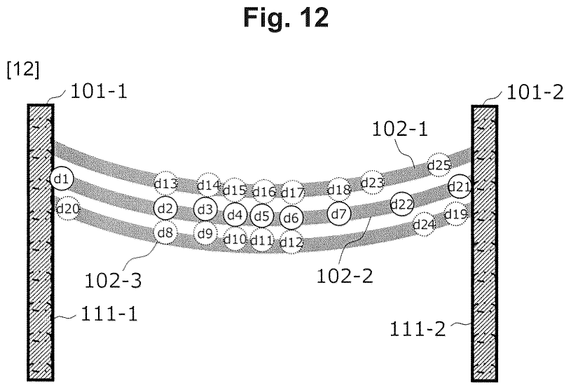

Specifically, in step S311, the arithmetic processing unit 3 superimposes an image (S2), and after the superimposition, the point cloud and the image are associated with each other, and color information of the image at the same position on the image is assigned to each point cloud. For example, as illustrated in FIG. 12, color information of the cable 102-2 is assigned to the points d1 to d7, d21, and d22 overlapping the cable 102-2.

In the present embodiment, in step S111, the arithmetic processing unit 3 automatically determines how far pixels of the same color as the color point cloud of the extracted three-dimensional model spread on the image by image analysis. For example, as illustrated in FIG. 5, the x coordinate of the left end pixel p1 of the cable 102-2 and the x coordinate of the right end pixel p22 of the cable 102-2 are determined, and the range of the cable 102-2 on the x axis is determined.

When the range in which the pixels of the same color spread on the image is determined in step S112, the arithmetic processing unit 3 creates the model again from the point cloud within the range using the point cloud within the threshold designated in advance from the extension line of the approximate line of the three-dimensional model (S113 to S116 and S313). For example, the points d1 to d25 exist in a range on the x axis of the cable 102-2. In this case, the arithmetic processing unit 3 creates the three-dimensional model again using the point cloud within the threshold from the extension line of the three-dimensional model 112-1 superimposed on the cable 102-2 from the points d1 to d25.

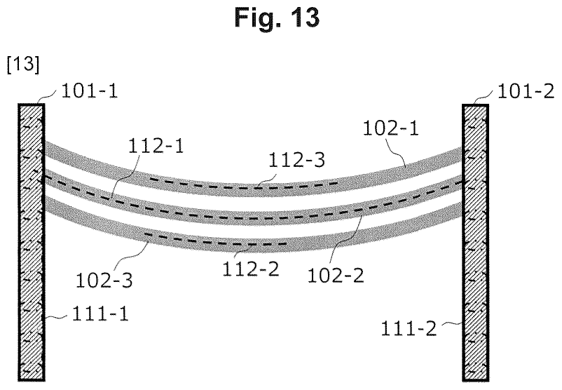

Here, for example, regarding the threshold, assuming that a direction in which the three-dimensional model extends is an x axis, a depth is a y axis, and a height direction is a z axis, by setting Δx<30 mm, Δy<30 mm, and Δz<30 mm, and a point cloud that will be used for the three-dimensional model can be extracted. As a result, as illustrated in FIGS. 12, d21 and d22 are set as a point cloud constituting the three-dimensional model (S115), and as illustrated in FIG. 13, the three-dimensional model is created again (S313).

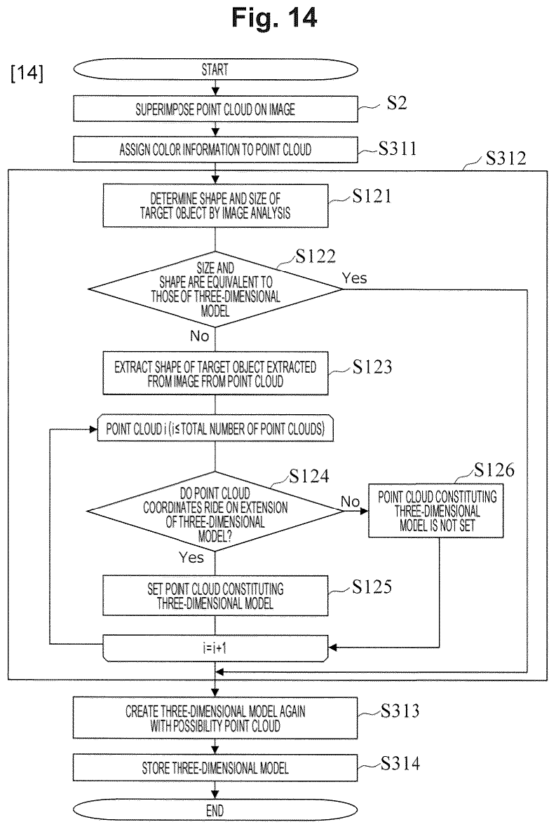

FIG. 14 illustrates an example of the second method.

The arithmetic processing unit 3 executes the following processing.
S2: Superimpose the point cloud and the image.
S311: Assign color information to the point cloud.:
S121: Estimate the shape and size of the target object by image analysis.
S122: Compare the target object extracted by the image analysis and the three-dimensional model extracted from the point cloud, and compare the shapes and sizes with each other to check whether they are the same.
S123: Extract the target object extracted from the image from the point cloud. As a result, a point cloud to be a possibility for the three-dimensional model is extracted.
S124 to S126: Determine whether the extracted point cloud is a possibility for the three-dimensional model.

S313: Create the three-dimensional model again using the possibility point cloud, and correct the shape of the three-dimensional model. Specifically, create the three-dimensional model again using the feature point cloud.
S314: Store the final three-dimensional model and end the process.

In the present embodiment, in step S121, the arithmetic processing unit 3 automatically extracts the target object on the image to be compared with the three-dimensional model based on a dictionary learned in advance by image analysis. For example, the arithmetic processing unit 3 extracts the cable 102-2 from the image illustrated in FIG. 8 using image analysis, and reads the size and shape of the cable 102-2 from the dictionary.

Then, in step S122, the arithmetic processing unit 3 compares the size and shape of the three-dimensional model with the size and shape of the target object determined by the image analysis. For example, the arithmetic processing unit 3 compares the size and shape of the three-dimensional model 112-1 with the size and shape of the cable 102-2 estimated in step S121.

Then, in a case where the size and shape of the target object estimated by the image analysis in step S121 are larger than those of the three-dimensional model 112-1, the three-dimensional model is created again from the point cloud within the range of the size and shape of the cable 102-2 estimated by the image analysis using the point cloud within the threshold designated in advance from the extension line of the approximate line of the three-dimensional model (S123 to S126 and S313). The concept of the threshold is similar to that in steps S114 to S116.

### Second Embodiment

In the present embodiment, the arithmetic processing unit 3 estimates the created three-dimensional model shape and enlarges the three-dimensional model to a certain size according to the shape. When hitting a point having a color different from that of the color point cloud used for model creation, the three-dimensional model is enlarged to that extent. Assuming that the three-dimensional model is made of a color point cloud to which color information of the same color is assigned, it is possible to create a corrected three-dimensional model by enlarging the three-dimensional model according to the shape of the three-dimensional model.

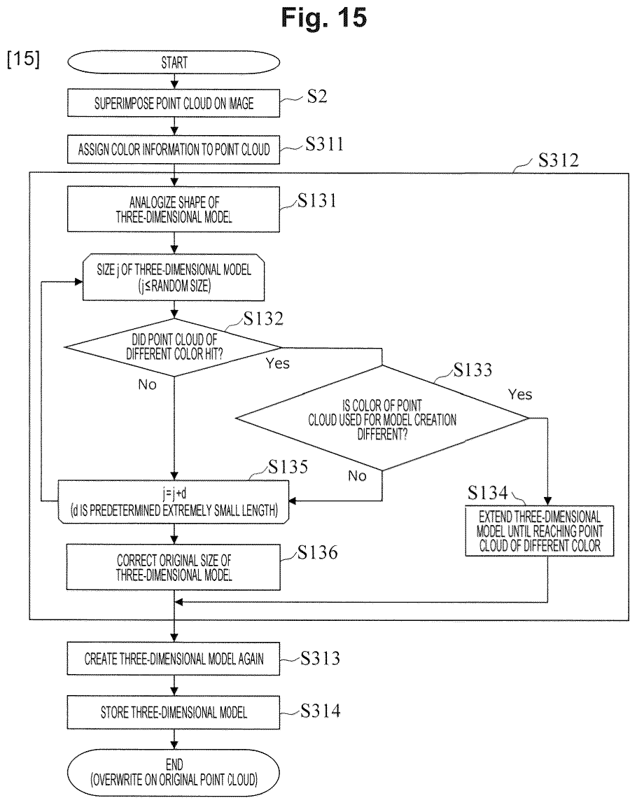

FIG. 15 illustrates a specific example of step S3. In the present embodiment, the arithmetic processing unit 3 superimposes the point cloud and the image (S2), and assigns color information to the point cloud (S311). The arithmetic processing unit 3 determines which facility model the three-dimensional model is, based on the color information assigned to the point cloud, and analogizes the shape (S131). Then, the three-dimensional model automatically extends to a random size in a random direction (S132 to S136). In the extension of the three-dimensional model in step S134, for example, an approximate line of the created three-dimensional model is extracted, and the model is created again using a point cloud within a threshold from the extension line of the approximate line. As the approximate line, an approximate curve or a catenary curve can be used.

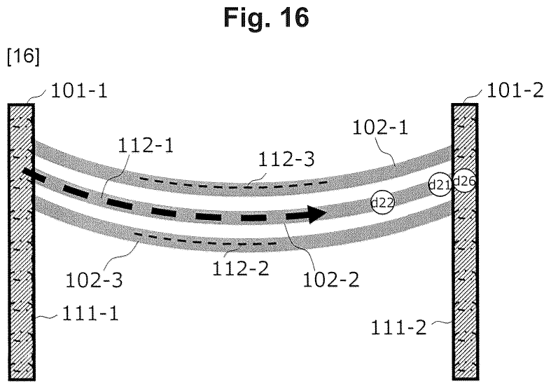

Specifically, the arithmetic processing unit 3 determines whether the size of the three-dimensional model hits a point cloud of a different color (S132). When there is no hitting in step S132, the three-dimensional model extends (S135), and the process proceeds to step S132. For example, as illustrated in FIG. 16, when the three-dimensional model 112-1 extends, the color information of the point d22 remains as a cable. In this case, the process proceeds to step S132.

On the other hand, in the case of hitting in step S132, the arithmetic processing unit 3 determines whether the point clouds of different colors exceed the density threshold (S133). When the difference does not exceed the threshold in S133 (No), the three-dimensional model extends again (S135), and the process proceeds to step S132.

When the difference exceeds the threshold in S133 (Yes), the arithmetic processing unit 3 creates a three-dimensional model using the point clouds of different colors as endpoints (S134). For example, as illustrated in FIG. 16, when the three-dimensional model 112-1 extends, the color information of the point d26 is the utility pole 101-2. In this case, the three-dimensional model 112-1 is created with the point d26 located in front of the point d21 as an endpoint (S313).

When the feature point cloud is not found even when the three-dimensional model 112-1 extends to the set random size, the arithmetic processing unit 3 corrects the three-dimensional model to the original size (S136), creates the three-dimensional model (S313), and stores the three-dimensional model (S314). When the three-dimensional model is created again in step S31, all the point clouds within the threshold from the approximate line of the three-dimensional model may be used. The threshold is set similarly to S113 to S116, and the distance from the approximate line to the point cloud is set as the threshold.

As described above, in the present embodiment, the arithmetic processing unit 3 extends the approximate line of the three-dimensional model, and in a case where a boundary where the color changes and is configured at a certain point cloud density or more can be found, the boundary is set as an endpoint of the three-dimensional model. Whether or not the color has changed is determined with reference to color information such as RGB values. For example, the arithmetic processing unit 3 superimposes the color point cloud or the point cloud on the image as the color information to be automatically determined as the color change point when the change is equal to or greater than a value designated in advance, then extracts a place at a certain point cloud density or more on the extension line of the approximate line of the three-dimensional model on the image, and can use the color information of the pixel at the same place.

In the present embodiment, when a point cloud serving as a boundary even at a long distance can be acquired from the fixed three-dimensional laser scanner 1-1 with respect to a target object having a characteristic shape, a three-dimensional model can be created accurately. For example, in the case of a cable, a three-dimensional model can be created at a place at a short distance from the fixed three-dimensional laser scanner, and a catenary curve can be estimated. The cable is installed on a wall surface of a utility pole or a house, the color of the cable is different from the color of the wall surface of the utility pole or the house when viewed in an image, and thus it is easy to distinguish the cables, and it is easier to acquire than the cable endpoint. These point clouds may be used as endpoints to extend the three-dimensional model. Accordingly, it is possible to create an accurate three-dimensional model.

In addition, it is possible to accurately extend the three-dimensional model using the approximate line by learning in advance what shape the created three-dimensional model originally has.

### INDUSTRIAL APPLICABILITY

The present disclosure can be applied to the information and communication industry.

### REFERENCE SIGNS LIST

1-1 Fixed three-dimensional laser scanner
1-2 Camera
2 Storage medium
3 Arithmetic processing unit
4 Apparatus
91 Point
92 Line
100 Target object
101-1, 101-2 Utility pole
102-1, 102-2, 102-3 Cable
111 Utility pole model
112 Cable model

1. An apparatus wherein
a three-dimensional model of a target object is created from point cloud data in which each point represents three-dimensional coordinates,
the three-dimensional model is superimposed on an image in which a target object of the three-dimensional model is photographed,
a point cloud to be added to a point cloud that constitutes the three-dimensional model is selected by comparing the target object in the image with the three-dimensional model, and
the three-dimensional model of the target object is created again including the point cloud to be added.

2. The apparatus according to claim 1, wherein
a point cloud within a threshold from an approximate line of the three-dimensional model is selected as the point cloud to be added.

3. The apparatus according to claim 1, wherein the target object in the image is compared with the three-dimensional model using a color of the target object in the image.

4. The apparatus according to claim 3, wherein
color information of the target object in the image is assigned to each point superimposed on the target object, and
the point cloud to be added is selected by comparing a range of point clouds having the same color information as the target object with the three-dimensional model.

5. The apparatus according to claim 3, wherein
color information of the target object in the image is assigned to each point superimposed on the target object, and
the point cloud to be added is selected by extending the three-dimensional model until a point cloud having different color information from the target object appears.

6. The apparatus according to claim 1, wherein
a size of the target object in the image is acquired by referring to a database storing information on the size of a random target object, and
the point cloud to be added is selected by comparing the size of the acquired target object with the three-dimensional model.

7. A method comprising:
creating a three-dimensional model of a target object from point cloud data in which each point represents three-dimensional coordinates;
superimposing the three-dimensional model on an image in which a target object of the three-dimensional model is photographed;
selecting a point cloud data to be added to a point cloud data that constitutes the three-dimensional model by comparing the three-dimensional model with the target object in the image; and
creating the three-dimensional model of the target object again using the point cloud data including the point cloud to be added.

8. A non-transitory computer-readable medium having computer-executable instructions that, upon execution of the instructions by a processor of a computer, cause the computer to function as the apparatus according to claim 1.
